(19) United States
(12) Patent Application Publication
(10) Pub. No.: US 2003/0036298 A1
(43) Pub. Date: Feb. 20, 2003

(54) Snap-on connector lock

(75) Inventors: Edward K. Hoffman, Anaheim, CA (US); Andrew D. Jackson, Lomita, CA (US)

Correspondence Address: DiPINTO & SHIMOKAJI, P.C., Suite 480, 1301 Dove Street, Newport Beach, CA, 92660, US

(73) Assignee: The Boeing Company, Seattle, WA

(21) Appl. No.: 09/933,248

(22) Filed: Aug. 20, 2001

(51) Int. Cl. H01R 13/62

(52) U.S. Cl. 439/152; 439/180

(57) ABSTRACT

A connector lock for securing and supporting a fully engaged connector assembly against disconnect even when subjected to vibrational forces experienced during launch into outer space. The connector lock includes a base portion and a pair of end portions extending substantially parallel to each other. Each end portion includes a pair of spaced-apart arms formed of flexible material and positioned so as to flex apart as a connector assembly is inserted between the arms. The arms snap back toward their original positions to prevent inadvertent release of the connector assembly.

### BACKGROUND OF THE INVENTION

The present invention generally relates to connectors of the type employed to electrically or optically connect signals, power and/or RF between units or interconnects such as payload to a harness. In particular, the present invention is directed to an improved connector lock capable of maintaining a pair of connectors fully engaged over the life of the connector even when subjected to vibration as may occur when the payload and connectors are launched into space.

Connectors are continually being redesigned and upgraded to continuously operate in numerous environments as may occur when connected to payloads launched into space. Plastic connectors have long been employed because of their light weight and low cost low cost of manufacture. Recently, a new generation of connectors formed of metals such as aluminum have been utilized to join space bound payloads with their respective wiring harnesses. Such changes in the design and material employed in the connectors were considered necessary to overcome problems including mounting, outgassing, shielding and reliability long associated with plastic connectors. One such new connector utilizes a nickel over aluminum design.

However, a problem associated with all types of connectors still exists: how to ensure that the two connector halves remain connected during operation even when subjected to the type of vibration encountered during launch of a payload into space. In addition, it is necessary to provide quick access during integration and test to the connector(s) while, at the same time, allowing ease of mounting to surface substrates.

A number of problems confront known connector assemblies. Current connector assemblies usually provide no way of quickly and inexpensively locking interfacing connectors together to form a continuous pathway. Current connector assemblies when assembled cannot be quickly uncoupled from one another without disassembly of the entire system. Most connector assemblies do not provide visual indicators showing the full thread engagement of the connectors. Finally, the mounting and securing of many connectors requires special bracketry which can add significantly to the weight and cost of the overall assembly.

A number of techniques have been employed in order to be assured that a pair of connectors remain in their assembled positions interfacing with one another. For example, the connectors may be staked (bonding with or without an epoxy agent) or even lock-wired together to prevent separation. Each of these techniques is labor intensive, significantly adding to the overall expense. In order to be assured that the connectors are fully engaged, it may be necessary to apply torque to the coupling, a labor-intensive step. In addition, inspections for quality of workmanship can be labor intensive as well as time consuming. Finally, it is necessary when mounting the connectors to tie them back against the harness bundle or else brackets would have to be made and mounted into a bracket, adding weight and increasing the labor and material costs.

There is clearly a need for a locking device capable of releasably retaining a pair of connectors in their assembled positions without requiring staking, wiring or otherwise creating a permanent connection. The device must be capable of withstanding both stress and strain including, but not limited to, the vibration generated when a payload is carried in flight or even launched into outer space. The locking device should only be capable of use when the connectors are fully engaged with each other. Finally, the locking device should be able to support the connectors without the need for additional brackets or support members.

### SUMMARY OF THE INVENTION

In one aspect of the present invention, a locking device formed in accordance with the present invention provides a positive, snap-lock, to a pair of mated connectors only after they are fully connected to one another. The device may include first and second pairs of flexible arms spaced from each other, wherein each pair of arms face each other and are connected by a curved body portion. Each pair of arms are separated by a distance such that each pair of arms flex away from each other as a connector is pressed between the arms. Once the connector comes to rest on the curved body portion, the arms are free to return, i.e., snap back to their original positions, locking the connector against the curved body portion. The first and second pairs of flexible arms may be spaced a distance such that each pair of pair of arms will connect a similarly-shaped portion of one of the connectors only if the connectors are fully engaged with each other. If the connectors are not fully engaged, the flexible arms can not be sufficiently flexed apart to allow the connector to be inserted therebetween, i.e., the arms can not snap back to their original positions. In effect, the locking device will interfere with the outside diameter of the connector, preventing installation. The present invention provides an easy and fool-proof method of visually determining whether or not the connectors are fully engaged when placed within the locking device.

The locking device of present invention may be formed with a flat base which allows for easy mounting of the locking device to any flat surface. If desired, a through hole may be drilled through the base, allowing the assembly to be screw mounted to an adjacent surface. When mounted, the locking device may serve as both a lock and a bracket capable of supporting the connector assembly. When it becomes necessary to separate the connectors from each other, it is merely necessary to pull the connectors away from the curved body portion with sufficient force to flex the pairs of arms away from each other. The snap-lock feature allows the connectors to completely separate from the locking device.

In another aspect of the invention, a method is provided for easy assembly of a pair of connectors in their fully engaged positions. The connectors are first brought into their fully engaged positions relative to one another and then the assembled connectors are snapped into place adjacent the curved portion of the locking device. The flexible arms are then released to return to their original positions, locking the connector assembly in its fully engaged position.

It is conservatively estimated that the present invention may reduce manufacturing cycle time during factory integration of about 3 days in touch labor. In addition, it may save cost in associated bracketry to hold/mount connectors in place of about 8 days in design and machine shop time, while reducing the defect rate from 20% to less than 2%.

These and other features, aspects and advantages of the present invention will become better understood with reference to the following drawings, description and claims.

### BRIEF DESCRIPTION OF THE DRAWINGS

FIG. 1 is a perspective view of a connector lock assembly of the present invention;

FIG. 2 is a perspective view of the connector lock assembly of FIG. 1 supporting a pair of fully engaged connectors;

FIG. 3 a cross-section view taken along the X-X axis in FIG. 1; and

FIG. 4 is a side view taken along the Y-Y axis in FIG. 1.

### DETAILED DESCRIPTION OF THE INVENTION

The following detailed description is of the best currently contemplated modes of carrying out the present invention. The description is not to be taken in a limiting sense, but is made merely for the purpose of illustrating the general principles of the invention, since the scope of the invention is best defined by the appended claims.

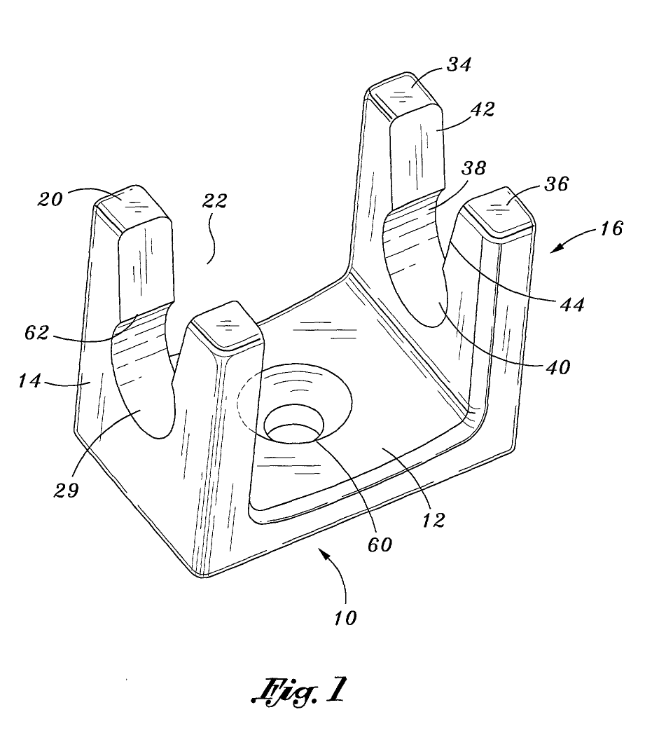

Referring to FIG. 1, a connector lock assembly 10 may include a generally rectangular base 12 and a pair of parallel extending ends 14 and 16, respectively. The ends 14 and 16 may be of similar size and shape.

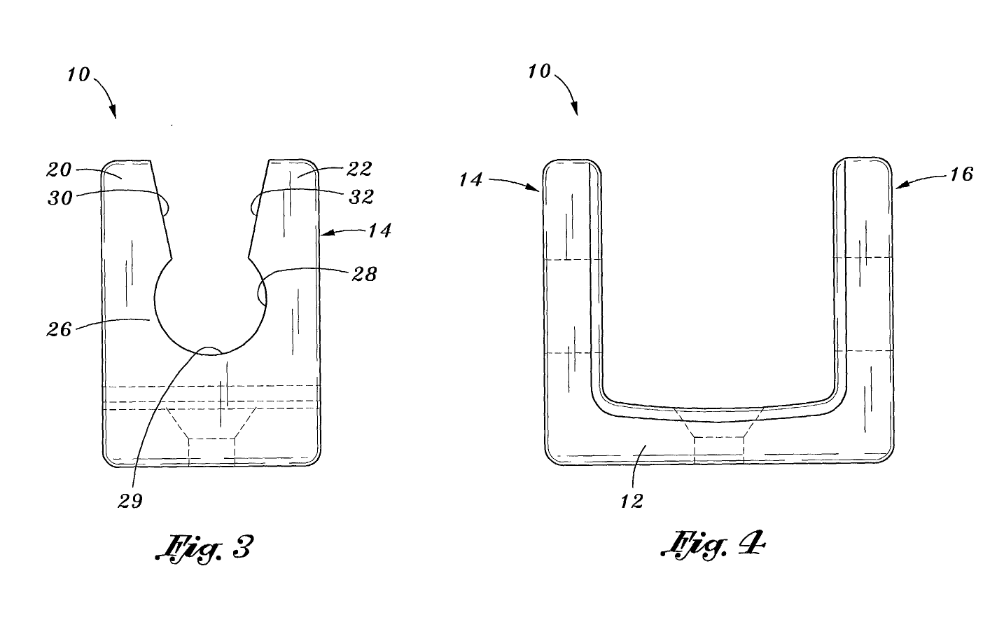

As shown in FIGS. 1 and 3, end 14 can include a pair of spaced-apart, flexible arm portions 20 and 22. The arms 20 and 22 may be formed with inner portions 26 and 28 that may be curved and which join each other to form a continuous support surface 29 that may be curved and capable of cradling and supporting a fully engaged connector as will be explained. The arm portions 20 and 22 can include confronting inclined surfaces 30 and 32 which slope or incline away from each other as the distance increases from support surface 29. The purpose of having the inclined portions will be described below.

Because end 16 can be similar in shape to end 14, it may also includes a pair of spaced-apart flexible arm portions 34 and 36 each formed with inner curved portions 38 and 40 and outer inclined surface portions 42 and 44, respectively. As with end 14, each of the curved portions 38 and 40 can be joined to form a continually curved surface 46 capable of cradling and supporting a fully engaged connector. Similar to end 14, each of the confronting inclined surfaces 42 and 44 may incline away from each other as the distance increases from curved surface 46.

While connector lock 10 may be formed of nickel over aluminum, it is within the scope of the present invention to form lock 10 of any nickel-like metallic coating material covering any similar construction material provided there is a sufficient degree of mobility to allow the arm portions 20 and 22, as well as arm portions 34 and 36, to flex away from each other when a connector is inserted between the arm portions, with the arms returning or “snapping back” to their original positions to frictionally hold the connector in place.

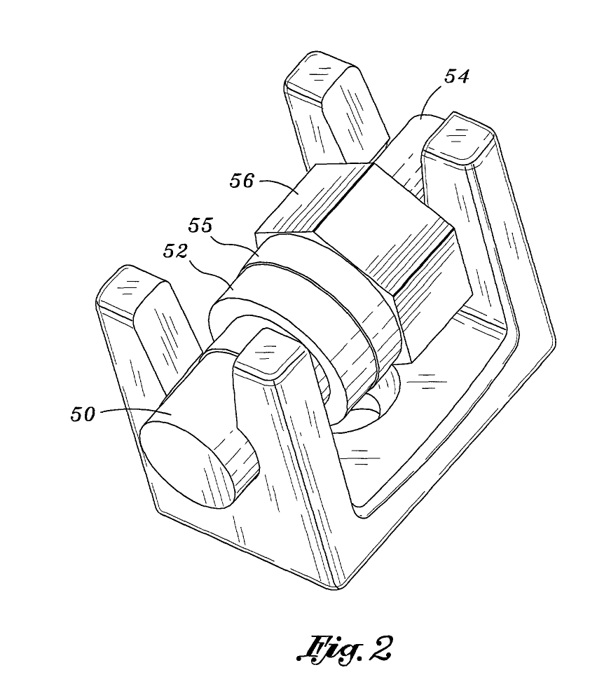

In one aspect of the invention, connector lock 10 may be utilized to cradle and support a pair of fully engaged connectors having cylindrical outer diameters with attachment features similar to the “Mini Connectors” produced by GlenAirs and shown in FIG. 2. As shown, a first connector member 50 can end in an interface 52, while a second connector 54 can end in interface 55. In order to fully engage connectors 50 and 54, torque can be applied to a hex nut 56 formed on connector 54. Once the connectors 50 and 54 are fully engaged to one another, each connector can be positioned adjacent one of the ends 14 or 16 of connector lock 10. As pressure is applied to the connectors, the pairs of flexible arm portions 20, 22, and 34, 36 may be forced or flexed apart. The connectors then may slide down the inclined surfaces of the arm portions, coming to rest against the continually curved surfaces 29 and 46. At this point, the arm portions 20, 22, 34 and 36 are free to return or “snap back” toward their original positions. The arm portions can engage the outer surface of the connectors 50 and 54 to prevent inadvertent separation of the connectors from connector lock 10. The amount of pressure exerted by the arm portions 20, 22, 34 and 36 against the connectors may be controlled by design of the shape of the opening formed between the arm portions as well as the material utilized in constructing connector lock 10. The arm portions can be designed to return or “snap back” to their original positions or they may not quite reach their original positions, providing additional pressure on the outer surface of the connector members 50 and 54.

One of the significant advantages of the present invention resides in the ability to immediately ascertain whether the connectors 50 and 54 are fully engaged without performing labor intensive tool or visual test/inspection. If the connectors 50 and 54 are not fully engaged, the hex nut 56 will be aligned with one of the ends 14 or 16, making it impossible to separate the arm portions a sufficient distance to allow for insertion of the connector. Only when the connectors 50 and 54 are fully engaged will hex nut 56 not interfere with insertion of the connectors into connector lock 10.

A further advantage of the present invention resides in the fact that connector lock 10 may also serve as bracket for supporting the assembled connectors 50 54. Referring again to FIG. 1, a through hole 60 may extend through the center of base 12. An attachment member such as a screw or bolt, not shown, may be inserted through hole 60 to attach base 12 to a substrate. It is also within the scope of the present invention to attach connector lock 10 to a substrate by direct bonding or any other conventional fastening means. Regardless of how it is attached, connector lock 10 serves to cradle and support the assembled connectors in place even when subjected to intense vibrations.

It is within in the scope of the present invention to alter the shape of arm portions 20, 22, 34 and 36 as needed to conform to the shape of the outer surface of connector arms 50 and 54. In one aspect of the invention, the curved surfaces 29 and 46 are of semi-circular cross section to conform to cylindrical outer surfaces of the connectors. Alternatively, the curved surfaces 29 and 46 may assume any curved shape as needed. In a similar manner, the size of connector lock 10 is considered a design choice. When utilized with the “Mini Connectors,” the ends 14 and 16 may extend less than approximately 0.669 inches from base 12 and be separated by approximately 0.150 inches. Arm portions 20 and 22, as well as 34 and 36, may be approximately 0.135 inches thick with the curved portions 29 and 46 each having a radius of approximately 1.50 inches. While the exact size of the connector lock 10 is a design choice and may very depending on the size and shape of the connectors, the dimensions as provided can lead to a better understanding of the relative size of the various portions of connector lock 10.

In another aspect of the invention, a method of easily mounting a connector assembly is provided without the need for visual inspection to assure full engagement. The connectors 50 and 54 are brought end-to-end and fully engaged with one anther. This may include torqing the connectors through use of hex nut 56 or by any conventional means. Once the connectors are thought to be fully engaged, the connector assembly is pressed against arm portions 20, 22, 34 and 36 until the arms separate. This allows the connectors to pass between the arm portions until coming to rest against the curved portions 29 and 46. At this time the separation pressure against the arm portions is withdrawn, allowing the arm portions to return or “snap back” toward their original, unbiased positions. This, in turn, can apply pressure against the outer surface of each connector, forcing the connector against the curved portion of each end 14 and 16. In addition, the inclined portion of each arm portion can provide a ridge 62 which applies additional pressure against the connector. In order to remove the connectors, the arm can be pried apart an initial distance to allow movement of the connectors away from each curved portion. In effect, each arm portion functions to drive the connectors into tight engagement with connector lock 10.

It should be understood, of course, that the foregoing relates to preferred embodiments of the invention and that modifications may be made without departing from the spirit and scope of the invention as set forth in the following claims.

We claim:

1. A connector lock assembly for securing and supporting a fully engaged connector assembly, comprising:
a body portion;
first and second end portions extending from opposite end of the body portion;
the first and second end portions each having a pair of spaced-apart arms;
an inner portion extending between each pair of spaced-apart arms; and
each pair of spaced-apart arms being disposed to flex apart as connector assembly is inserted into the connector lock assembly before returning back toward their original positions to secure and support the connector assembly.

2. The connector lock according to claim 1, wherein the first and second end portions extend substantially parallel to each other.

3. The connector lock according to claim 1, wherein each pair of spaced-apart arms extend substantially parallel to each other.

4. The connector lock according to claim 3, wherein each pair of spaced-apart arms include inclined facing portions extending away from each other as the distance from the base increases to facilitate insertion of the connector assembly.

5. The connector lock according to claim 4, wherein said inner portions together form a continuous support portion extending between the spaced-apart arms.

6. The connector lock according to claim 3, wherein the distance between a portion of each pair of spaced-apart arms is less then the diameter of the fully engaged connector assembly, requiring each pair of spaced-apart arms to flex apart as the connector assembly is inserted into the connector lock.

7. The connector lock according to claim 5, wherein the inclined portion of each of the spaced-apart arms includes a ridge which engages and presses the connector assembly toward the curved portion to secure the connector assembly within the connector lock.

8. The connector lock according to claim 1, wherein at least the end portions are constructed of a flexible, metallic structure

9. The connector lock according to claim 8, wherein at least the end portions are constructed of a nickel coating over a metallic structure.

10. The connector lock according to claim 8, wherein the connector lock is constructed of a nickel coating over an aluminum structure.

11. A connector lock assembly for securing and supporting a pair of fully engaged connectors, comprising:
a body;
first and second parallel extending end portions attached to the body;
the first and second end portions each having a pair of flexible arms;
the arms each having a curved portion, forming a continuous support surface; and
each pair of flexible arms positioned to temporarily flex away from each other as the connector assembly is inserted into the connector lock, whereby the arms return to their original positions.

12. The connector lock according to claim 11, wherein each pair of flexible arms extend substantially parallel to each other.

13. The connector lock according to claim 12, wherein each pair of flexible arms include confronting inclined portions that extend away from each other to facilitate insertion of the connector assembly into engagement with the continuous support surface.

14. The connector lock according to claim 12, wherein the distance between each pair of flexible arms is less then the outside diameter of the fully engaged connector assembly, forcing each pair of arms to flex apart as the connector assembly is inserted into the connector lock.

15. The connector lock according to claim 13, wherein the inclined portion of each of the flexible arms includes a ridge engaging and pressing the connector assembly toward the continuous curved portion, thereby securing the connector assembly within the connector lock.

16. The connector lock according to claim 11, wherein at least the end portions are constructed of Nickel over Aluminum.

17. A connector lock for securing a connector assembly, comprising:
a body including a base and a pair of integrally formed ends extending substantially parallel to each other;
each of the ends including a pair of arm portions having confronting surfaces including a curved portion and an inclined portion; and
each pair of arms positioned such that the inclined surfaces flex away from each other as the connector assembly is inserted toward the curved portions.

18. The connector lock according to claim 17, wherein each pair of arms snap back to their original positions when the connector assembly makes contact with the curved portions.

19. The connector lock according to claim 17, wherein each arm includes a ridge engaging and pressing the connector assembly toward the curved surface to secure the connector assembly into engagement with the connector lock assembly.

20 The connector lock according to claim 17, wherein the body is constructed of a nickel coating over a metallic structure.

21. A method of securing the connection of a pair of connectors, comprising:
engaging said connectors to one another;
inserting each of said connectors into a respective pair of arm portions such that said arm portions are forced apart from one another;
supporting said connectors by a support surface adjacent said arm portions; and
allowing said arm portions to move back toward one another.

22. The method of claim 21, wherein inserting said connectors further comprises moving said connectors past inclined surfaces of said arm portions.

23. The method of claim 21, wherein allowing said arm portions to move back occurs after supporting said connectors.
